(19) United States
(12) Patent Application Publication
(10) Pub. No.: US 2008/0159489 A1
(43) Pub. Date: Jul. 3, 2008

(54) System and method for providing an announcement indicating the status of a called party

(75) Inventors: Feng Xu, Qingdao (CN); Seaman Ming Chen, Qingdao (CN); Ming Ai Chi, Qingdao (CN)

Correspondence Address: HARNESS, DICKEY & PIERCE, P.L.C., P.O. BOX 8910, RESTON, VA, 20195, US

(73) Assignee: LUCENT TECHNOLOGIES INC

(21) Appl. No.: 11/802,481

(22) Filed: May 23, 2007

(30) Foreign Application Priority Data
Dec. 29, 2006 (CN) 200610064441.3

(51) Int. Cl. H04M 1/64

(52) U.S. Cl. 379/88.12

(57) ABSTRACT

One embodiment of the method includes the steps of receiving a call destined for a called party from a calling party, determining if a status announcement service has been activated for the called party, and delivering a status announcement to the calling party if the determining step determines that the status announcement service has been activated for the called party.

### PRIORITY STATEMENT

This non-provisional U.S. patent application claims priority under 35 U.S.C. § 119 to Chinese Patent Application No. 200610064441.3, filed on Dec. 29, 2006, the entire contents of which is incorporated herein by reference.

### BACKGROUND OF INVENTION

1. Field of the Invention

The present invention is related to a system and method for telecommunications. More particularly, the present invention relates to a system and method for providing an announcement indicating the status of a called party.

2. Background Information

When a person is traveling on vacation or on a business trip, the person may miss calls placed to the person's home or office terminal. Further, if a person is traveling on vacation or on a business trip, the person's wireless communication device may not be supported in the vacation or business trip location(s).

In conventional communication systems, when a person is away from his local terminal (e.g., home or office telephone) or his wireless communication device is not supported in a location, a party calling the person at the local terminal or wireless communication device will be forced to leave a message on a voicemail or will simply have to try calling the person again at a later date.

As such, a calling party, which is used herein to refer to any number of people, is generally not provided any information as to the status of the person the calling party is attempting to contact.

Even if a person has a conventional voicemail service or message recording machine allowing the person to change the message when away from his local terminal, the time and number of operations that must be performed generally dissuades the person from changing the message. For example, a person may have to call the voicemail service, navigate several menus and record a status message to replace the normal message and then perform these operations a second time to replace the status message with the normal message when the person returns.

### SUMMARY OF THE INVENTION

One or more example embodiments of the present invention are directed towards a system and/or method for providing an announcement indicating the status of a called party.

An example embodiment of the present invention provides a method of processing a call. The method includes the steps of receiving a call destined for a called party from a calling party, determining if a status announcement service has been activated for the called party, and delivering a status announcement to the calling party if the determining step determines that the status announcement service has been activated for the called party. The status announcement service may indicate the location of a called party and/or contact information for the called party.

Further, the method may include the step of accessing a record for the called party. The record includes an indication of whether the status announcement service has been activated for the called party and thus, the record may be used to determine if the status announcement service has been activated for the called party. The record may also include a plurality of calling party groups for the called party, and each calling party group may be associated with a different status announcement. Accordingly, the delivering step delivers the status announcement associated with the calling party group of which the calling party is a member if the determining step determines that the status announcement service has been activated for the called party.

Still further, the method may include the steps of receiving input from the called party indicating to activate the status announcement service, and updating the record to indicate the status announcement service has been activated.

Another example embodiment of the present invention provides a communication system. The communication system includes a controller and a multimedia server. The controller receives a call destined for a called party from a calling party and determines if a status announcement service has been activated for the called party. The multimedia server stores status announcements and delivers a status announcement to the calling party if the controller determines that the status announcement service has been activated for the called party.

Further, the system may include a database storing a record for the called party. The record includes an indication of whether the status announcement service has been activated for the called party. Therefore, the controller may access the record for the called party and determine if the status announcement service has been activated for the called party based on the record. The record may also include a plurality of calling party groups for the called party, and each calling party group is associated with a different status announcement. As such, the multimedia server may deliver the status announcement associated with the calling party group of which the calling party is a member if the controller determines that the status announcement service has been activated for the called party.

Still further, the system may include an application server. The application server receives input from the called party indicating to activate the status announcement service and updates the record to indicate the status announcement service has been activated.

Still another example embodiment of the present invention is directed to a communication device. The communication device includes at least one shortcut button for activating and deactivating a status announcement service managed by an application server. The communication device may also include a plurality of shortcut buttons including at least one first button for activating a predetermined status announcement and a second button for activating a customized message recorded after the second button is triggered.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 is a block diagram of an example communication network architecture for implementing a method for providing an announcement indicating the status of a called party according to an example embodiment of the present invention;

FIG. 2 is a flow chart illustrating a method for providing an announcement indicating the status of a called party according to an example embodiment of the present invention; and

FIG. 3 is a flow chart illustrating a method for providing an announcement indicating the status of a called party according to another example embodiment of the present invention.

### DETAILED DESCRIPTION OF EXAMPLE EMBODIMENTS

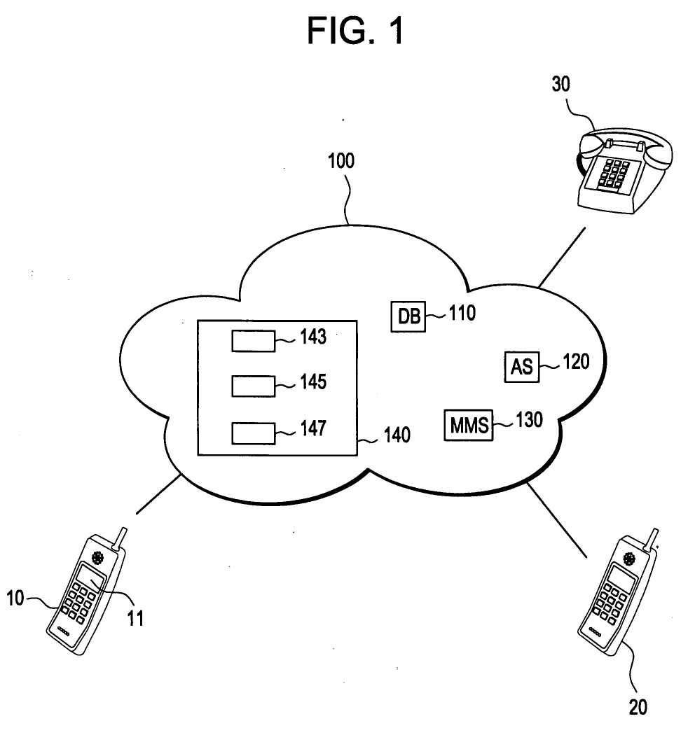

FIG. 1 is a block diagram of an example communication network architecture suitable for implementing a method for providing an announcement indicating the status of a called party according to an example embodiment of the present invention. One skilled in the art will appreciate that various details of the communication network architecture explained below with respect to example embodiments of the present invention may vary without departing from the scope of the present invention.

In FIG. 1, a communication network 100 is shown as connecting various communication devices such as mobile terminals 10, 20, landline terminal 30, Internet Protocol Multimedia Subsystem (IMS) terminals, personal digital assistants (PDAs), facsimile machines, personal computers, etc.

The example communication network 100 shown in FIG. 1 includes a user database 110, application server 120, a multimedia server 130 and a controller 140. One skilled in the art will appreciate that the communication network 100 may be an Internet Protocol Multimedia Subsystem (IMS). An IMS provides network operators and service providers, such as telephone companies, the ability to control and charge for services provided. An IMS generally operates using Internet Protocol (IP) and supports existing packet-switched and circuit-switched communication systems.

The user database 110 of the communication network 100 stores records related to subscribers and/or communication devices. For example, a subscriber record may include identification information relating to the subscriber, the subscriber's communication device, services subscribed to by the subscriber, etc. The user database 110 may be updated in a variety of manners and at a variety of times. For example, a service provider may update the user database 110 when a subscriber subscribes to a new service, modifies an existing service, changes communication devices, relocates, etc. The user database 110 may also authenticate communication devices based on information received from a network switch (not shown) as is well-known in the art. In an IMS, the user database 110 is referred to as a Home Subscriber Server (HSS). The HSS is the master user database that supports the IMS network entities that are actually handling the calls. Accordingly, the HSS stores subscriber records, performs authentication and authorization of a user and/or subscriber of the IMS and can provide information about the physical location of the user and/or subscriber.

The application server 120 of the communication network 100 provides one or more services to users of the communication network 100. For example, a company may maintain an application server 120 running applications for hosting and/or executing one or more services including caller identification services, call waiting, call forwarding, conference call services, voicemail, multimedia services (MMS), etc. The application server 120 may be located in a home network and/or an external third-party network. Further, the application server 120 may be implemented as a separate physical entity (e.g., a separate server) or as an enhanced application included on an existing server. According to an example embodiment of the present invention, the application server 120 controls calls relating to and/or affected by a service that allows a subscriber to provide a status announcement to callers when the subscriber is away from or unavailable at the subscriber's terminal.

The multimedia server 130 provides media used in various applications, which may be controlled by the application server 120. The media may include information used for playing announcements, multimedia conferencing, text-to-speech conversion, etc. According to an example embodiment of the present invention, an announcement service is provided allowing the subscriber to provide a status announcement to callers when the subscriber is away from or unavailable at the subscriber's terminal. Accordingly, the multimedia server 130 may maintain a database of different announcements available to and/or used by subscribers.

The controller 140 is used to handle signaling between components of the example communication network 100. In an IMS, the controller 140 may be implemented as a plurality of session initiation protocol servers or proxies collectively referred to as Call Session Control Function (CSCF). According to an example embodiment of the present invention, the controller 140 may handle the signaling between one or more of the mobile terminals 10, 20, the landline terminal 30, the user database 110, the application server 120, the multimedia server 130, other IMS entities, etc.

For ease of explanation, the controller 140 herein is referred to as a single system including a central processing unit (CPU) 143, a memory 145 and a transceiver 147. The CPU 143 and memory 145 are used for performing various tasks of the controller 140, and the transceiver 147 is used for communicating data to and from various devices, systems and/or entities such as the landline terminal 30, wireless mobile terminals 10, 20, the user database 110, the application server 120 and the multimedia server 130.

According to an example embodiment of the present invention, the service provider provides a service that allows a subscriber to provide a status announcement to callers when the subscriber is away from or unavailable at the subscriber's terminal. For example, the subscriber may wish to leave a message indicating the subscriber is in a meeting, at lunch, on vacation, etc. Still further, the subscriber may wish to leave a message instructing a calling party to contact another number for immediate assistance. In addition, the service may allow the subscriber to play different status messages to different groups of people. For example, a status message may be tailored to a high priority client. In this example, if the high priority client calls, the client receives the status message, whereas if a new customer or telemarketer calls, the new customer or telemarketer will receive a normal message that may not include any status information.

The subscriber registers for this service with the service provider, and may provide announcement parameter information at the time of registration or at any time up through and including activation of the service. The announcement parameter information includes information such as the numbers of calling parties to respond to with announcements, and the announcements to be provided.

For example, upon activation of the status announcement service (described in detail below), the application server 120 requests the announcement parameter information from the subscriber. The announcement parameter information may simply be recording an announcement to be played to all calling parties. However, a more complicated and tailored announcement service may be provided.

For example, the subscriber may create groups of calling party numbers and record a different announcement in association with each group. It will be understood that the creation of the groups of calling party numbers may require subscriber input. The subscriber input may take the form of key entry using the subscriber's communication device (e.g., devices 10, 20, 30, etc. shown in FIG. 1). The subscriber input may also be supplied verbally. Here, the application server 120 invokes the use of well-known voice recognition technology to interpret the subscriber input. As a further alternative, the subscriber may access a web page of the application server 120, and supply the announcement information via the web page. It will be appreciated that this form of inputting subscriber input allows the subscriber to enter an audio file as an announcement.

Beside announcements recorded by the subscriber, the announcements may instead take the form of providing a contact number for the subscriber, location of the subscriber, etc. The form and content of the announcement are not limited in the present invention. Furthermore, the manner in which the announcement information is gathered and recorded is not limited by the present invention.

It is contemplated that the announcements themselves may be stored by the application server 120 in the multimedia server 130. The announcement parameter information may be stored as part of the subscriber profile record in the database 110. The subscriber profile record also includes a status announcement service flag indicating whether the status announcement service has been activated.

According to an example embodiment of the present invention, the status announcement service may be activated by a shortcut button. As shown in FIG. 1, the shortcut button 11 may be located on a communication device's control panel. For example, the landline terminal 30 may have several shortcut buttons 11 each used to activate or trigger a different status message that is played to a calling party when the subscriber is away from the landline terminal 30.

Further, the landline terminal 30 may include a customized shortcut button, which when pushed causes the service to instruct the subscriber to record a customized message that is played when the subscriber is away from the landline terminal 30. Accordingly, when the customized shortcut button is pushed, the application server 120 may instruct the multimedia server 130 to store an announcement.

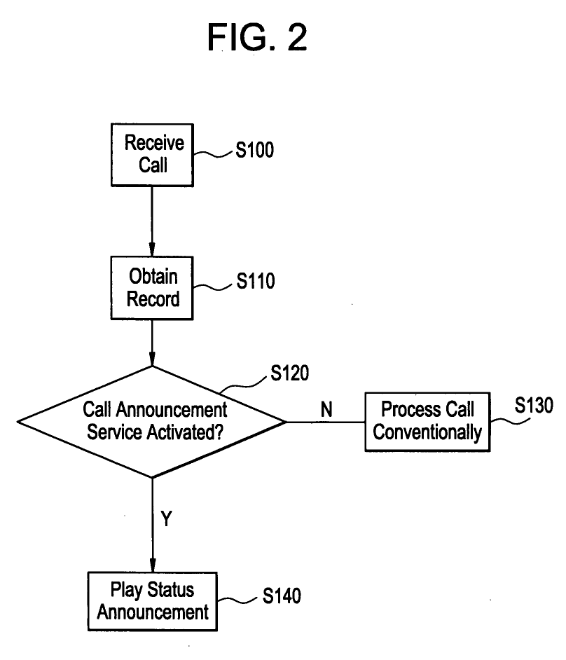

Next, an embodiment of the present invention will be described in detail with respect to FIG. 2. FIG. 2 is a flow chart illustrating a basic method for providing an announcement indicating the status of a called party according to an example embodiment of the present invention. As shown, in step S100, the controller 140 receives a call from a calling party. The call is destined for a called party, and the called party is identified by a called party number used by the calling party to originate the call. In step S110, the controller 140 accesses the subscriber profile record for the called party using the calling party number. The controller 140 determines whether the status announcement service has been activated for the called party based on the status announcement service flag in the accessed record in step S120.

If the status announcement service has not been activated, then the call is processed in the conventional manner in step S130. However, if the status announcement service has been activated, then in step S140, the controller 140 access the status announcement from the multimedia server 130, and delivers (or plays) the announcement for the calling party.

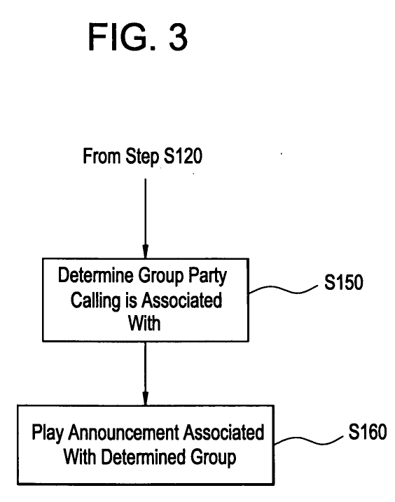

Next, an embodiment of the present invention will be described in detail with respect to FIG. 3. FIG. 3 is a flow chart illustrating a more complicated and tailored method for providing a status announcement indicating the status of a called party according to an example embodiment of the present invention. Namely, this embodiment pertains to the alternative discussed above in which the subscriber creates groups of calling party numbers and records a status announcement (same or different) in association with each group. As shown, the method of FIG. 3 includes the same steps S100-S130 as in FIG. 2. However, after determining that the status announcement service has been activated in step S120, the controller 140 then determines with which of the calling party groups the calling party is associated in step S150.

Then, in step S160, the controller 140 accesses the status announcement associated with the determined calling party group from the multimedia server 130 and delivers (or plays) the status announcement to the calling party.

Example embodiments of the present invention being thus described, it will be obvious that the same may be varied in many ways. Such variations are not to be regarded as a departure from the invention, and all such modifications are intended to be included within the scope of the invention.

What is claimed:

1. A method of processing a call, comprising:
receiving a call destined for a called party from a calling party;
determining if a status announcement service has been activated for the called party; and
delivering a status announcement to the calling party if the determining step determines that the status announcement service has been activated for the called party.

2. The method of claim 1, wherein the status announcement indicates at least one of a location of a called party and contact information for the called party.

3. The method of 1, further comprising:
accessing a record for the called party, the record including an indication of whether the status announcement service has been activated for the called party; and wherein
the determining step determines if the status announcement service has been activated for the called party based on the record.

4. The method of claim 3, wherein
the record includes a plurality of calling party groups for the called party, each calling party group is associated with a different status announcement; and
the delivering step delivers the status announcement associated with the calling party group of which the calling party is a member if the determining step determines that the status announcement service has been activated for the called party.

5. The method of claim 3, further comprising:
receiving input from the called party indicating to activate the status announcement service; and
updating the record to indicate the status announcement service has been activated.

6. The method of claim 1, further comprising:
receiving input from the called party indicating to activate the status announcement service.

7. A communication system comprising:
a controller receiving a call destined for a called party from a calling party and determining if a status announcement service has been activated for the called party; and
a multimedia server storing status announcements and delivering a status announcement to the calling party if the controller determines that the status announcement service has been activated for the called party.

8. The system of claim 7, wherein the status announcement indicates at least one of a location of a called party and contact information for the called party.

9. The system of claim 7, further comprising:
a database storing a record for the called party, the record including an indication of whether the status announcement service has been activated for the called party; and wherein
the controller accesses the record for the called party and determines if the status announcement service has been activated for the called party based on the record.

10. The system of claim 9, wherein
the record includes a plurality of calling party groups for the called party, each calling party group is associated with a different status announcement; and
the multimedia server delivers the status announcement associated with the calling party group of which the calling party is a member if the controller determines that the status announcement service has been activated for the called party.

11. The system of claim 9, further comprising:
an application server receiving input from the called party indicating to activate the status announcement service, and updating the record to indicate the status announcement service has been activated.

12. The system of claim 7, further comprising:
an application server receiving input from the called party indicating to activate the status announcement service.

13. A communication device, comprising:
a shortcut button for activating a status announcement service, the service announcement service providing parties calling the communication device with a status announcement regarding a subscriber of the communication device.

14. The communication system of claim 13, wherein the shortcut button is a plurality of shortcut buttons on the communication device.
